(19) United States
(12) Patent Application Publication
(10) Pub. No.: US 2019/0330757 A1
(43) Pub. Date: Oct. 31, 2019

(54) METAL-CLAY NANOCOMPOSITE COATINGS FOR CORROSION RESISTANCE

(71) Applicant: University of North Texas, Denton, TX (US)

(72) Inventors: Teresa GOLDEN, Denton, TX (US); Ryan DAUGHERTY, Denton, TX (US)

(73) Assignee: University of North Texas, Denton, TX (US)

(21) Appl. No.: 16/391,552

(22) Filed: Apr. 23, 2019

Related U.S. Application Data
(60) Provisional application No. 62/662,586, filed on Apr. 25, 2018.

(51) Int. Cl. C25D 15/00; C09K 15/02; B32B 43/00; C25D 3/12

(52) U.S. Cl. CPC C25D 15/00; C25D 3/12; B32B 43/006; C09K 15/02

(57) ABSTRACT

Electrochemical synthesis and electrodeposition of corrosion resistant metal-ionic clay nanocomposite coatings. The coatings comprise a zinc-aluminum based layered double hydroxide nanoplatelets incorporated into a nickel matrix. The coatings can be deposited onto such as a metal surface by way of electrodeposition. Electrodeposition of the corrosive resistant coatings described here have an average platelet size of about 631±43 nm and crystallite size from about 25 nm to about 45 nm.

### RELATED APPLICATIONS

This application claims priority under 35 U.S.C. § 119(e) to U.S. Provisional Patent Application No. 62/662,586 filed Apr. 25, 2018, which is incorporated herein by reference.

### BACKGROUND OF THE INVENTION

Substantial research has focused on metal matrix composite coatings for improved physical properties and corrosion resistance. Inclusion of ceramic nanoparticles into a metal matrix can increase hardness, improve thermal stability, and provide better tribological properties. Ceramic materials such as Al₂O₃, TiO₂, CeO₂, and ZrO₂ incorporated within metal matrices have improved the mechanical properties of the electrodeposited coatings. Additionally, previous work has demonstrated the value of embedding exfoliated montmorillonite (a cationic clay) nanoparticle platelets into nickel, Ni—Mo, and Cu—Ni coatings. These coatings had smaller crystallite size, as well as improved corrosion resistance when exposed to sodium chloride solutions, compared to the pure metal coatings.

Layered double hydroxides (LDHs), a class of anionic clays with a wide variety of available elemental compositions, are promising materials for integration into metal and alloy coatings as a means to improve corrosion properties. The crystalline layers comprise a combination of divalent and trivalent metal hydroxides in a sheet-like lattice framework with the general formula [M(II)₍₁₋ₓ₎M′(III)ₓ(OH)₂]^{x+}Aⁿ⁻_{x/n}.mH₂O, where M and M′ are a metal species, A is a charge balancing anion in the interlayer, n is the valence charge of the anion, and m is the empirical molar coefficient of complexed water. Trivalent species substitution causes the LDH lattice to exhibit a strong net positive charge due to a forced octahedral geometry. Accompanying anion species each electrostatically bind to two of these sheets to form large, net-neutral layered structures. The elemental composition, size, and anionic exchange capacity are variable and can be controlled through the synthetic process.

Most of the 56-known divalent-trivalent combinations are capable of exhibiting multiple M(II):M(III) ratios. The wide range of possible combinations is what makes combining LDH nanoparticles into metal coatings interesting, possibly giving unique and tunable properties. These anionic clays have already proved to be successful materials for corrosion resistance as pure coatings or as additives within polymer coatings. However, incorporation into a metal matrix has not been explored. A good metal candidate to combine with LDH nanoplatelets is nickel, since it is easy to electrodeposit and itself offers beneficial corrosion protection. Nickel coatings provide toughness and good general corrosion resistance but are susceptible to pitting and microbial induced corrosion, thus necessitating alloying or inclusion of additives to improve their service life. However, producing these types of metal-LDH nanocomposite coatings when using electrodeposition has several obstacles that must be overcome.

LDH delamination to obtain individual nanoplatelets is difficult in water and has been reported only under certain circumstances. Standard LDH delamination is therefore unsuitable for direct electrosynthesis of metal-LDH composite coatings. Studies have shown that delaminating LDH compared to other silicate clays is difficult due to the increased surface charge, but several techniques have been developed to accomplish delamination. Techniques such as stirring, sonication, or heated refluxing tend to lead to relatively low amounts of suspended LDH colloids. Substitution of larger anionic species in between the layers, known as intercalation, is needed to facilitate the delamination process. Intercalation can be done by replacing the common chloride, carbonate, and nitrate ions typically present after LDH synthesis with other species such as sodium dodecylsulfate (SDS). After expansion of the interlayer, delamination can be achieved in organic solvents, such as formamide or various alcohols. Such delamination is possible due to the low polarity of these solvents and stable colloids are commonly produced from this procedure. Adachi-Pagano and coworkers (Chem. Commun. 2000, 91-92) showed that delamination of Zn—Al LDH-DS could be carried out via heated reflux in the presence of a variety of alcohols. Butanol (BuOH) produced the highest LDH loadings of the alcohols tested, up to 1.5 g/L.

Accordingly, there is a need for methods to incorporate LDH into a metal matrix by techniques other than delamination. There is also a need for methods to form new nanocomposite coatings that overcome the current challenges associated with LDH delamination and electrodeposition processes. Addressing these challenges may require novel modifications of the plating bath and development of new electrodeposition techniques.

### SUMMARY

To our knowledge the incorporation of LDH into a metal matrix using electrosynthesis has not been reported in literature. This disclosure describes the challenges of LDH incorporation into metal coatings and studies the properties, morphology, and corrosion resistance of a metal-LDH nanocomposite coating formed from an electrodeposition process.

A method was developed to electrochemically synthesize metal-anionic clay nanocomposite coatings. The coatings comprise divalent and trivalent layered double metal hydroxide (LDH) nanoplatelets incorporated into a nickel matrix (Ni-LDH). The coatings were evaluated for their corrosion resistance versus pure nickel coatings on steel substrates. LDH nanoplatelets integrated into the nickel coatings were synthesized from zinc and aluminum nitrate salts using a refluxing coprecipitation method. These nitrate platelets were intercalated with sodium dodecylsulfate, increasing the gallery spacing from 9.06 Å to 37.6 Å, followed by refluxing in butanol to delaminate the LDH crystal sheets, giving a 1.5 g/L loading of LDH in the continuous phase. The average platelet size measured by dynamic light scattering (DLS) was 631±43 nm. Aliquots of the delaminated LDH colloid were added to a modified nickel bath for electrodeposition. Challenges to electrodepositing these metal anionic clay nanocomposites from an aqueous bath were evaluated. EDS analysis confirmed the presence of the nanoplatelets in the metal coating. The resulting nanocomposite films have a preferred (220) orientation and crystallite sizes ranging from 25-45 nm as measured by x-ray diffraction (XRD). Corrosion resistance of the coatings was measured in 3.5% NaCl with potentiodynamic polarization and electrochemical impedance spectroscopy. Corrosion resistance of the coatings, when compared to pure nickel coatings, was improved.

Accordingly, the disclosure herein provides a nickel-clay nanocomposite comprising:
a) nickel metal; and
b) a clay nanoplatelet comprising a delaminated layered double hydroxide having a divalent metal hydroxide and a trivalent metal hydroxide;

wherein the clay nanoplatelet is dispersed in the nickel metal to form a nickel-clay nanocomposite, and the nickel-clay nanocomposite comprises nickel crystallites having a dimension of about 10 nm to about 100 nm, and an X-ray reflection of 111, 200, 220, 311, or a combination thereof.

This disclosure also provides a method of inhibiting corrosion of a metal surface comprising coating a metal surface with the nanocomposite described above, thereby inhibiting corrosion of the metal surface.

Additionally, this disclosure provides a method of coating a surface with a corrosion inhibitor comprising:
a) delaminating a layered double hydroxide (LDH) with a (C₃-C₁₀)alkanol to form a delaminated layered double hydroxide colloid; and
b) electroplating a metal surface with an electrolyte mixture comprising the delaminated layered double hydroxide colloid and a nickel salt, wherein the metal surface is thereby electroplated with a coating of a nickel-clay nanocomposite;

wherein the nickel-clay nanocomposite comprises clay nanoplatelets and nickel crystallites;

wherein the clay nanoplatelets have a lateral dimension of about 300 nm to about 3000 nm and comprise a delaminated layered double hydroxide (DLDH) having a divalent metal hydroxide and a trivalent metal hydroxide;

wherein the nickel crystallites have a dimension of about 10 nm to about 100 nm, and an X-ray reflection of 111, 200, 220, 311, or a combination thereof.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. Overview of the layered double hydroxide colloid synthesis and Ni-LDH metal matrix nanocomposite coating process.

FIG. 2. FT-IR spectra of a) LDH-NO₃ (solid line), and b) LDH-DS (dotted line) powders scanned from 450-4000 cm⁻².

FIG. 3. Powder XRD patterns of a) LDH-NO₃ (solid line), and b) LDH-DS (dotted line) powders.

FIG. 4. Powder XRD patterns for samples a) B1, b) B2, c) BL1, and d) BL2.

FIG. 5. SEM images of each nickel coating a) B1, b) B2, c) BL1, and d) BL2. Scale bars are 5 μm.

FIG. 6. Nyquist plots and fittings for nickel (B1, B2) and Ni-LDH (BL1, BL2) coatings after 4 days immersion in 3.5% NaCl, using the circuit displayed in the inset. Black lines are the Z-view fitting curves and symbols represent experimental data.

FIG. 7. Nyquist plots and fittings for BL1 and BL2 coatings after 10 days immersion in 3.5% NaCl. Black lines are the Z-view fitting curves and symbols represent experimental data.

FIG. 8. Linear polarization curves for Ni (B1, B2) and Ni-LDH (BL1, BL2) coatings after 4 days immersion in 3.5% NaCl.

FIG. 9. Photo of the LDH colloidal suspension in BuOH after delamination of LDH-DS.

FIG. 10. Cyclic voltammetry scans for a) B1, b) B2, c) BL1, and d) BL2. Insets are Randles-Sevcik plots run at scan rates of 10, 50, and 100 mV s⁻¹.

FIG. 11. Open circuit potential of Ni (B1, B2) and Ni-LDH (BL1, BL2) nanocomposite coatings monitored over 14 days in 3.5% NaCl.

### DETAILED DESCRIPTION

Previous research by our group has confirmed that incorporation of montmorillonite (a cationic clay) into a metal matrix can be accomplished electrochemically. Even though the montmorillonite is not electroactive, insertion into the metal coating can be achieved through a combination of gravity, complexation with positive metal cations, and stabilization of the platelets' solubility, due to pH fluctuations in the double layer during deposition. Various layered double hydroxides (LDHs) have been incorporated into polymer or resin matrices. However, incorporating LDH via electrodeposition into a metal matrix presents challenges that have to be addressed for successful nanocomposite coatings to be formed. These challenges include: 1) an organic phase at relatively high concentration in the plating bath is necessary to maintain the delamination of the LDH platelets, using organic solutions in electrochemistry, however, increases the resistivity of the solution and can inhibit the plating process; 2) the mass transfer method for the LDH platelets to the electrode surface is complicated, since the LDH platelets are not electroactive, and therefore a suitable technique is needed to ensure the nanoparticles reach the electrode surface during electrodeposition; and 3) the pH must be suitable for both metal deposition and LDH stability to prevent flocculation or degradation of the platelets.

A method was developed to electrochemically synthesize metal-anionic clay nanocomposite coatings. The coatings comprise of Zn—Al layered double hydroxide (LDH) nanoplatelets incorporated into a nickel matrix (Ni-LDH) and were evaluated for their corrosion resistance versus pure nickel coatings on steel substrates. The LDH nanoplatelets integrated into the nickel coatings were synthesized from zinc and aluminum nitrate salts using a refluxing coprecipitation method. These nitrate platelets were intercalated with sodium dodecylsulfate, increasing the gallery spacing from 9.06 Å to 37.6 Å, followed by refluxing in butanol to delaminate the LDH crystal sheets, giving a 1.5 g/L loading of LDH in the continuous phase. The average platelet size measured by dynamic light scattering (DLS) was 631±43 nm. Aliquots of the delaminated LDH colloid were added to a modified nickel bath for electrodeposition. Challenges to electrodepositing these metal anionic clay nanocomposites from an aqueous bath are reviewed and discussed. EDS analysis confirms the presence of the nanoplatelets in the metal coating. The resulting nanocomposite films have a preferred (220) orientation and crystallite sizes ranging from 25-45 nm as measured by XRD. Corrosion resistance of the coatings was also improved over the pure nickel coatings and measured in 3.5% NaCl with potentiodynamic polarization and electrochemical impedance spectroscopy. Suggestions for future design and improved properties are discussed for these types of nanocomposite coatings.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the end-points of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture.

The terms “inhibit”, “inhibiting”, and “inhibition” refer to the slowing, halting, or reversing the growth or progression of a disease, infection, condition, or group of cells. The inhibition can be greater than about 20%, 40%, 60%, 80%, 90%, 95%, or 99%, for example, compared to the growth or progression that occurs in the absence of the treatment or contacting.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

A “solvent” as described herein can include water or an organic solvent. Examples of organic solvents include hydrocarbons such as toluene, xylene, hexane, and heptane; chlorinated solvents such as methylene chloride, chloroform, and dichloroethane; ethers such as diethyl ether, tetrahydrofuran, and dibutyl ether; ketones such as acetone and 2-butanone; esters such as ethyl acetate and butyl acetate; nitriles such as acetonitrile; alcohols such as methanol, ethanol, n-butanol, sec-butanol, and tert-butanol; and aprotic polar solvents such as N,N-dimethylformamide (DMF), N,N-dimethylacetamide (DMA), and dimethyl sulfoxide (DMSO). Solvents may be used alone or two or more of them may be mixed for use to provide a “solvent system”.

The term “alkanol” refers to an “alkyl” or “cycloalkyl” that is substituted with a hydroxyl (—OH) moiety, generally referred to as an alcohol. Examples of alkyl and cycloalkyl moieties that can be substituted to provide suitable alkanols are described below.

The term “alkyl” refers to a branched or unbranched hydrocarbon having, for example, from 1-20 carbon atoms, and often 1-12, 1-10, 1-8, 1-6, or 1-4 carbon atoms. As used herein, the term “alkyl” also encompasses a “cycloalkyl”, defined below. Examples include, but are not limited to, methyl, ethyl, 1-propyl, 2-propyl (iso-propyl), 1-butyl, 2-methyl-1-propyl (iso-butyl), 2-butyl (sec-butyl), 2-methyl-2-propyl (t-butyl), 1-pentyl, 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, hexyl, octyl, decyl, dodecyl, and the like. The alkyl can be unsubstituted or substituted, for example, with one or more hydroxyl, halo, nitro, or amino substituents. The alkyl can also be optionally partially or fully unsaturated. As such, the recitation of an alkyl group can include both alkenyl and alkynyl groups.

The term “cycloalkyl” refers to cyclic alkyl groups of, for example, from 3 to 10 carbon atoms having a single cyclic ring or multiple condensed rings. Cycloalkyl groups include, by way of example, single ring structures such as cyclopropyl, cyclobutyl, cyclopentyl, cyclooctyl, and the like, or multiple ring structures such as adamantyl, and the like. The cycloalkyl can be unsubstituted or substituted. The cycloalkyl group can be monovalent or divalent, and can be optionally substituted as described for alkyl groups. The cycloalkyl group can optionally include one or more cites of unsaturation, for example, the cycloalkyl group can include one or more carbon-carbon double bonds, such as, for example, 1-cyclopent-1-enyl, 1-cyclopent-2-enyl, 1-cyclopent-3-enyl, cyclohexyl, 1-cyclohex-1-enyl, 1-cyclohex-2-enyl, 1-cyclohex-3-enyl, and the like.

The term “dimension” refers to a measure of length, width, or height (e.g. thickness). The term dimension may be used herein to refer to the characteristics of a crystallite, a nanoplatelet, or nanocomposite. As used herein the term “lateral dimension” may refer to the in-plane measurement of the nanoplatelet wherein the in-plane nanoplatelet measurement is the length and/or width of the nanoplatelet, typically referenced as the largest of those dimensions. For example, the lateral dimension of a nanoplatelet having a greatest length of 630 nm, a greatest width of 200 nm, and a greatest height (e.g. thickness) of 180 nm has a lateral dimension of 630 nm. Measurements of particles and the like can be taken by techniques such as x-ray diffraction (XRD) or dynamic light scattering (DLS).

### EMBODIMENTS OF THE INVENTION

This disclosure provides various embodiments of a nickel-clay nanocomposite comprising:
a) nickel metal; and
b) a clay nanoplatelet comprising a delaminated layered double hydroxide having a divalent metal hydroxide and a trivalent metal hydroxide;

wherein the clay nanoplatelet is dispersed in the nickel metal to form a nickel-clay nanocomposite, and the nickel-clay nanocomposite comprises nickel crystallites having a dimension of about 10 nm to about 100 nm, and an X-ray reflection of 111, 200, 220, 311, or a combination thereof.

In additional embodiments, the clay nanoplatelet has a lateral dimension of about 300 nm to about 3000 nm. In some embodiments, a layered double hydroxide (LDH) or a delaminated layered double hydroxide may comprise, but is not limited to, cations of calcium, magnesium, manganese iron, cobalt, nickel, antimony, copper, zinc, aluminum, nitrogen, or a combination thereof. In other embodiments, the LDH may comprise, but is not limited to, anions of chlorine, bromine, iodine, nitrate, carbonate, sulfate, hydroxide, selenium oxide, or a combination thereof.

In additional embodiments of this disclosure, the divalent metal of the divalent metal hydroxide is zinc. In some other embodiments, the trivalent metal of the trivalent metal hydroxide is aluminum. In additional embodiments, the crystallite has a dimension (or a length) of about 20 nm to about 60 nm. In yet other embodiments, the crystallite has a dimension of about 1 nm to about 100 nm, about 15 nm to about 30 nm, about 25 nm to about 50 nm, about 10 nm to about 40 nm, about 50 nm to about 80 nm, or about 40 nm to about 90 nm.

In various embodiments, the crystallite has a preferred or predominant X-ray reflection of 220. In additional embodiments, the divalent metal of the divalent metal hydroxide is zinc, the trivalent metal of the trivalent metal hydroxide is aluminum, the nickel crystallites have a dimension of about 20 nm to about 60 nm and (the crystallites have) a preferred X-ray reflection of 220, and wherein the nickel-clay nanocomposite is electroplated to a metal surface and inhibits corrosion of the metal surface.

In various embodiments, the nanocomposite is a layer of material having a thickness of about 10 nm to about 30 am, wherein the layer of nanocomposite covers at least a portion of metal surface, and the nanocomposite inhibits corrosion of the metal surface. In some embodiments, the nanocomposite thickness is about 10 nm to about 5 μm; about 5 μm to about 10 μm; about 10 μm to about 15 μm; about 15 μm to about 20 μm; about 20 μm to about 25 μm; about 25 μm to about 30 μm; about 10 nm to about 2 μm; about 2 μm to about 7 μm; about 7 μm to about 12 μm; about 12 μm to about 17 μm; or about 17 to about 22 μm. Longer electrodeposition exposure times allow for nanocomposite coatings of greater thickness (e.g., the techniques described in Example 5 below carried over longer periods of time). An entire metal surface may be coated, or optionally, lesser portions of the metal may be coated, for example, only surfaces that would be exposed to corrosive conditions or would be at risk of corrosion.

This disclosure also provides a method of inhibiting corrosion of a metal surface comprising coating a metal surface with a nanocomposite disclosed herein, thereby inhibiting corrosion of the metal surface. In other various embodiments, the metal surface is coated by electrodeposition. In other additional embodiments, the coating formed by electrodeposition has a polarization resistance (Rp) of about 200 kΩ cm² to about 500 kΩ cm². In other embodiments, the Rp is about 200 kΩ cm² to about 500 kΩ cm², about 200 kΩ cm² to about 300 kΩ cm², about 300 kΩ cm² to about 400 kΩ cm², or about 400 kΩ cm² to about 500 kΩ cm².

This disclosure also provides a method of coating a surface with a corrosion inhibitor comprising:
a) delaminating a layered double hydroxide (LDH) with a (C₃-C₁₀)alkanol to form a delaminated layered double hydroxide colloid; and
b) electroplating a metal surface with an electrolyte mixture comprising the delaminated layered double hydroxide colloid and a nickel salt, wherein the metal surface is thereby electroplated with a coating of a nickel-clay nanocomposite;

wherein the nickel-clay nanocomposite comprises clay nanoplatelets and nickel crystallites;

wherein the clay nanoplatelets have a lateral dimension of about 300 nm to about 3000 nm and comprise a delaminated layered double hydroxide (DLDH) having a divalent metal hydroxide and a trivalent metal hydroxide;

wherein the nickel crystallites have a dimension of about 10 nm to about 100 nm, and an X-ray reflection of 111, 200, 220, 311, or a combination thereof.

In some embodiments, the divalent metal of the divalent metal hydroxide is zinc, and the trivalent metal of the trivalent metal hydroxide is aluminum.

In various embodiments, the DLDH-colloid is prepared from an LDH. In other embodiments, the LDH has a basal spacing of about 5 angstroms to about 50 angstroms. In yet other embodiments the basal spacing is about 1 to about 100 angstroms, about 10 to about 40 angstroms, or about 50 to about 80 angstroms. In other embodiments, the DLDH (or colloid of DLDH) has a lateral dimension of about 300 nm to about 3000 nm. In some other embodiments, the lateral dimension or length is about 300 nm to about 500 nm, about 500 nm to about 800 nm, about 800 nm to about 1200 nm, about 1200 nm to about 1500 nm, about 1500 nm to about 1800 nm, about 1800 nm to about 2000 nm, about 2000 nm to about 2400 nm, about 2400 nm to about 2700 nm, or about 2700 nm to about 3000 nm.

In yet other embodiments the LDH is delaminated with butanol (for example, to provide the DLDH colloid). In some embodiments, the LDH, DLDH, or DLDH-colloid comprises a divalent zinc and a trivalent aluminum. In yet other embodiments, the LDH comprises an intercalated dodecylsulfate ion, wherein the LDH is a layered double hydroxide-dodecylsulfate (LDH-DS). In other words, the LDH comprises an intercalated dodecylsulfate (DS), wherein the LHD is LDH-DS.

In some embodiments, the LDH-DS is prepared from a layered double hydroxide-nitrate (LDH-NO₃), i.e., an LDH comprising an intercalated nitrate (NO₃), wherein the LDH is LDH-NO₃. In additional embodiments, the LDH-NO₃ (or LDH, LDH-DS, DLDH or DLDH-colloid) comprises a ratio of Zn:Al of about 2:1 to about 5:1. In other embodiments the ratio is about 3:1 or about 4:1.

In yet other embodiments, the electrolyte mixture comprises about 1 g/L to about 2 g/L of the delaminated layered double hydroxide colloid. In some other embodiments, the electrolyte mixture comprises the delaminated layered double hydroxide colloid in the amount of about 1.2 g/L to about 1.4 g/L, about 1.4 g/L to about 1.5 g/L, about 1.5 g/L to about 1.7 g/L, or about 1.7 g/L to about 1.9 g/L.

In various embodiments, the electrolyte mixture comprises a borate salt. In additional embodiments, the electrolyte mixture has a pH of about 2 to about 4. In other embodiments the pH is about 2.5, about 3.0, or about 3.5.

This disclosure provides ranges, limits, and deviations to variables such as volume, mass, percentages, ratios, etc. It is understood by an ordinary person skilled in the art that a range, such as “number1” to “number2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described above.

### Design and Synthesis Challenges for Metal-Anionic Clay Nanocomposite Coatings

How to Electrodeposit the Metal Nanocomposite Coatings from Aqueous-Organic Plating Baths.

The selection process of suitable organic modifiers was examined to facilitate codeposition of LDH within the nickel matrix. The most common continuous phases for delamination of LDH are medium chain alcohols. However, the addition of these unsaturated alcohols in too high concentrations shuts down the deposition reaction. Typically, no more than 50 mmol (˜0.05%) of saturated alcohol can be added to the plating solution without deleterious effects. Scant research has been conducted with saturated monols as additives for nickel electrodeposition. Previous work studied the effect of butanol addition in the plating bath for nickel deposition and revealed that nickel coatings could be deposited successfully from plating baths containing 5 and 10% butanol (BuOH). These concentrations are high enough to allow loading of delaminated LDH into the plating solutions without adversely affecting the nickel deposition. Butanol was selected as a prime candidate for delamination, due to its high loading capacity for LDH colloids, but had not been studied as a plating bath additive. Therefore, BuOH is a prime candidate as an additive in this study. Sodium borate was also selected as a bath additive for its exceptional complexing ability for nickel electrodeposition. Additionally, the borate is not a strong binding anion for LDH, due to its many coexisting forms in solution. It can also be used in high concentrations without detrimental adsorption onto the LDH platelets, affecting complexation with nickel. This aqueous-organic bath system can help stabilize the LDH nanoplatelets in solution during nickel deposition.

How to Encourage Incorporation of LDH Nanoparticle Platelets into the Nickel Matrix During Electrodeposition.

Depositions were carried out in an inverted electrochemical cell, similar to previous work performed by our group. The inverted cell design allows for better inclusion of LDH into the nickel films, where gravity and the positive charge of the platelets assist the migration of platelets to the electrode surface, with no observable flocculation during deposition. Nitrogen gas was bubbled through solution for convection and to prevent any possible flocculation of LDH on the electrode surface, which can inhibit deposition. A modified pulse reverse loop was used to help with migration problems, due to the low mobility of the nanoparticles into the double layer. The pulse loop was applied, and a scan rate chosen to allow sufficient repopulation of species near the electrode.

How to Prevent Destabilization and/or Flocculation of the LDH Platelets.

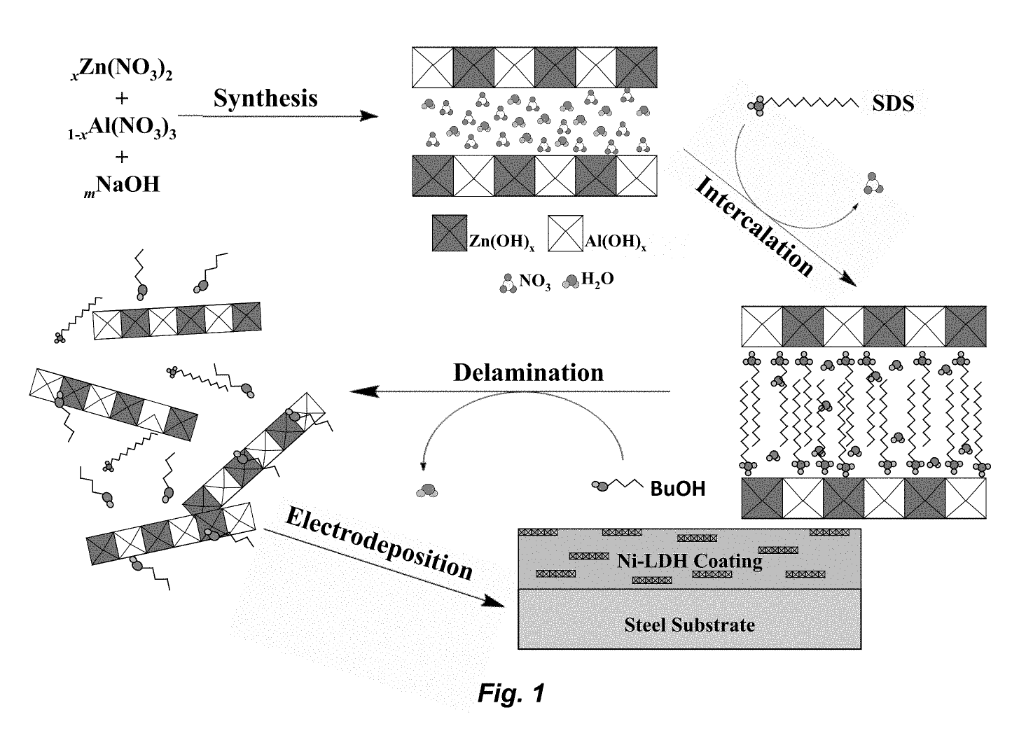

Using a pH of 3 allows for suitable nickel deposition while not damaging the crystalline structure of LDH during deposition. All plating baths were pH adjusted prior to the introduction of LDH and BuOH to prevent agglomeration and deterioration of the platelets. By addressing the above challenges, a Ni-LDH metal matrix nanocomposite coating on steel substrate. FIG. 1 illustrates the overall process developed to produce the LDH platelets, introduce delaminated LDH platelets into the modified plating bath, and electrodeposit smooth, uniform Ni-LDH nanocomposite coatings. Details of each of these steps and the results are expanded upon in the next section.

### Results and Discussion

### Characterization of LDH-NO₃ and -DS Powders and Colloids

Synthesis of LDH-NO₃ was carried out under nitrogen atmosphere to prevent contamination of C₀₂, since the carbonate ion binds strongly to LDH and prevents delamination. A coprecipitation method was chosen because the resultant LDH precipitate has smaller particle sizes and readily delaminates, unlike more crystalline samples derived from urea hydrolysis methods. Elemental analysis by AAS of the LDH-NO₃ precipitate indicated that for a 2:1 Zn:Al salt starting ratio, the crystalline solid formed had a ratio of 79:21 (±1.4) wt % Zn:Al. For both the coprecipitation steps and SDS intercalation, the precipitate was isolated by repeated washing with decarbonated water and ethanol, to remove adsorbed contaminants and excess surface water. The products were dried after washing, at 100° C. for 12 hrs. This temperature allowed for rapid desorption of excess water and some of the interlayer water without calcining the product. This step also allowed better FT-IR and pXRD diffraction analysis for the —NO₃ and -DS intercalated LDH.

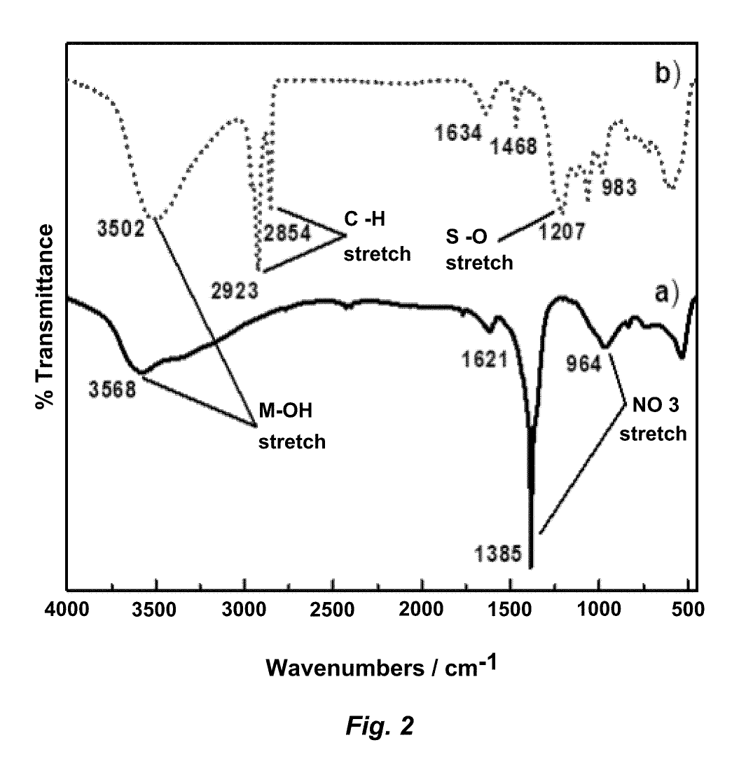

FT-IR spectroscopy results for LDH-NO₃ and LDH-DS powders are shown in FIG. 2 and consistent with literature. The spectrum for (a) LDH-NO₃ has two peaks for layer and interlayer O—H stretching and bending for the metal hydroxide and water at 3568 cm⁻¹ and 1621 cm⁻¹. The peaks at 1385 and 964 cm⁻¹ are due to NO₃ stretching and indicate NO₃⁻ in the interlayer spacing. The FT-IR results for (b) LDH-DS are also consistent with literature. The two C—H stretching peaks at 2854 and 2923 cm⁻¹, and S—O stretching from the sulfate head at 1207 cm⁻¹ are from the dodecylsulfate (DS) structure. The 1385 cm⁻¹ nitrate peak is not present for the LDH-DS sample, indicating successful intercalation of SDS and removal of nitrate ions from the interlayer of LDH.

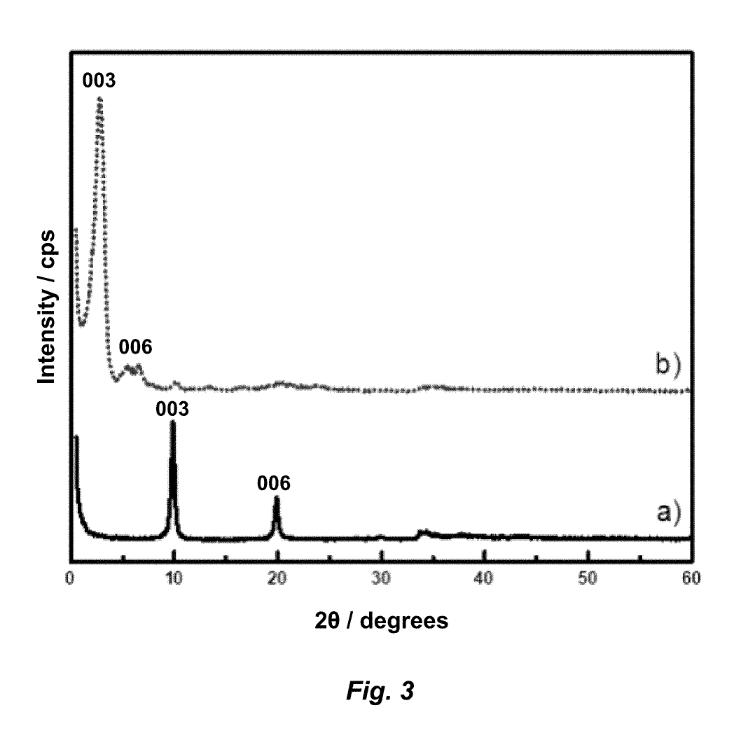

Powder XRD was run on LDH-NO₃ and LDH-DS powders, and the results shown in FIG. 3. Basal spacing for (a) LDH-NO₃ is 9.06 Å, indicated by the (003) reflection, which is slightly higher than typically reported. This is due to the additional water still left after the low temperature drying process. The LDH-DS powder results (FIG. 3b) show that both the (003) and (006) reflections are shifted to lower 20 values. This shift signifies an increase in basal spacing to 37.56 Å due to intercalation of DS in the interlayer and is consistent with literature. Both FT-IR and pXRD results show no evidence of carbonate contamination, which can inhibit intercalation and delamination of the LDH platelets.

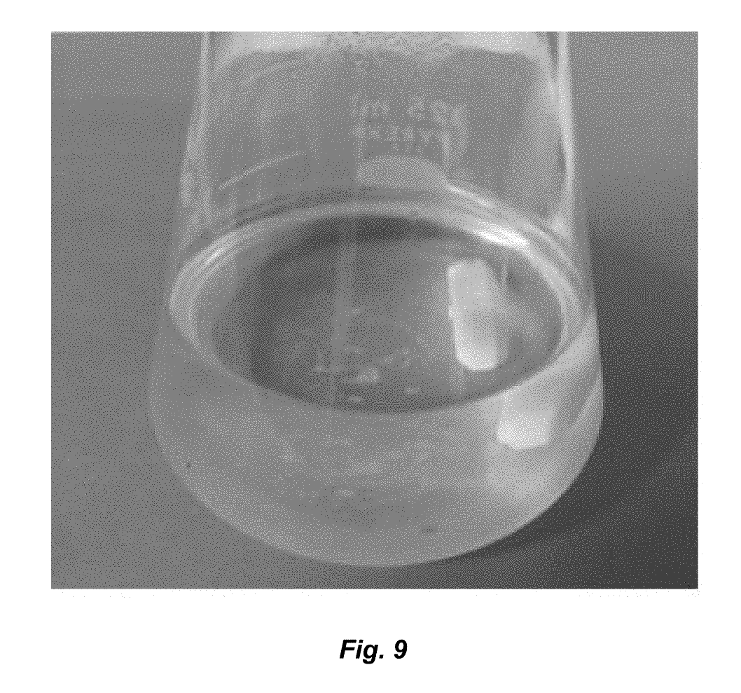

Delamination of the LDH-DS was accomplished after refluxing, giving 1.5±0.08 g of loading in the colloid. The colloid appearance changes from cloudy to translucent after delamination, signifying a change in particle size (FIG. 9). Particle size analysis was performed on the colloid to measure the size of delaminated LDH platelets in solutions containing electrolyte salts. These particle size values are listed in Table 1A. LDH solutions were measured after delamination (a) and after the delaminated solution pH was adjusted to 3.0 (b), since the electrodepositions were run at pH 3.0. The delaminated LDH particles show little size difference with a pH adjustment and have a lateral dimension of 500-800 nm. When NiSO₄ is added to the LDH solution (c), the particle size of LDH is unaffected by the addition of the electrolyte. However, when borate is added to the LDH suspension (d), a 3-fold increase in particle size indicates some association between the borate species in solution and the LDH particles. The addition of both nickel ions and sodium borate in the LDH solution (e) has a value in between samples (c) and (d), thereby indicating that when both LDH nanoparticles and nickel cations are present, these both compete to adsorb or complex with borate species in solution.

TABLE 1A
Particle size measured by DLS for (a) 20% delaminated LDH
colloid in BuOH/H₂O, (b) solution (a) adjusted to pH 3, (c) solution
(b) + 0.1M NiSO₄, (d) solution (b) ± 0.15M borate, (e)
solution (b) ± 0.1M NiSO₄ + 0.15M borate.

| | NiSO₂ | Na₂B₄O₇ | BuOH/H₂O | | LDH | Particle size |
|---|---|---|---|---|---|---|
| | (M) | (M) | (%) | pH | (wt. %) | (nm) |
| a | 0 | 0 | 20 | 8.2 | 0.04 | 631 ± 43 |
| b | 0 | 0 | 20 | 3.0 | 0.04 | 673 ± 198 |
| c | 0.1 | 0 | 20 | 3.0 | 0.04 | 620 ± 128 |
| d | 0 | 0.15 | 20 | 3.0 | 0.04 | 1793 ± 438 |
| e | 0.1 | 0.15 | 20 | 3.0 | 0.04 | 1335 ± 623 |

### Solution Studies of Ni-LDH Plating Baths

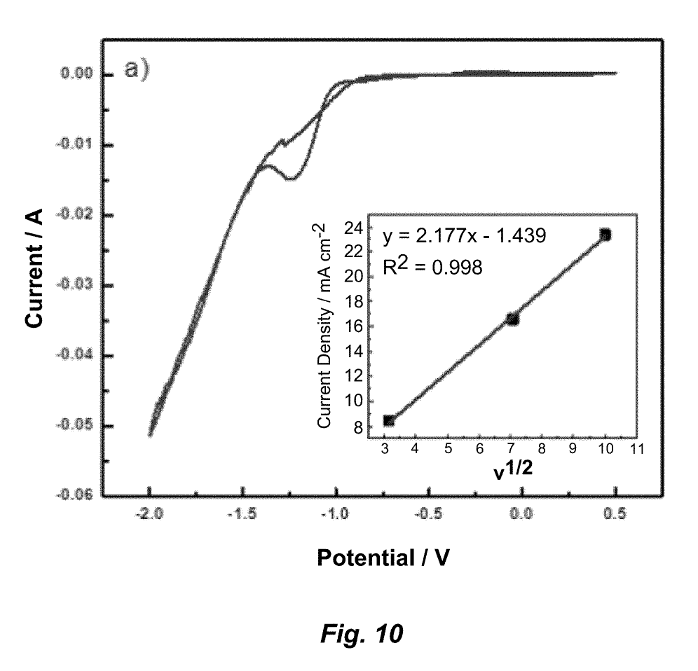

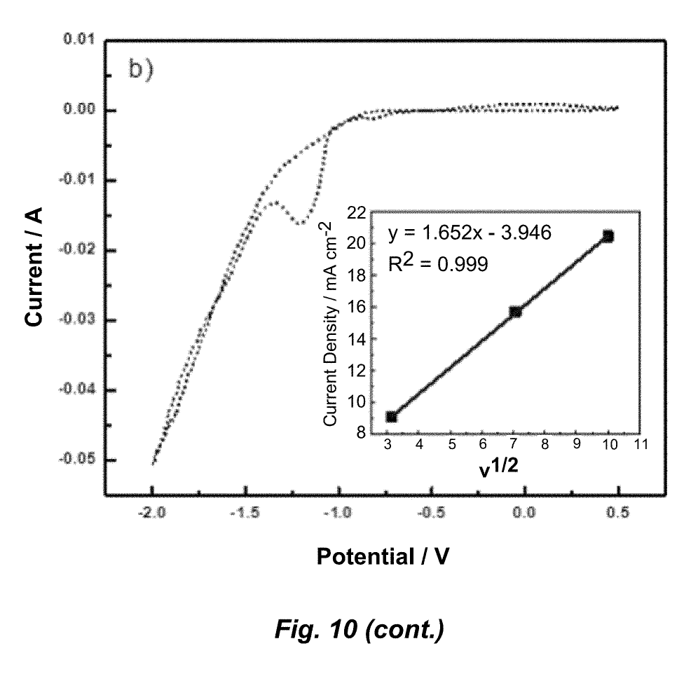

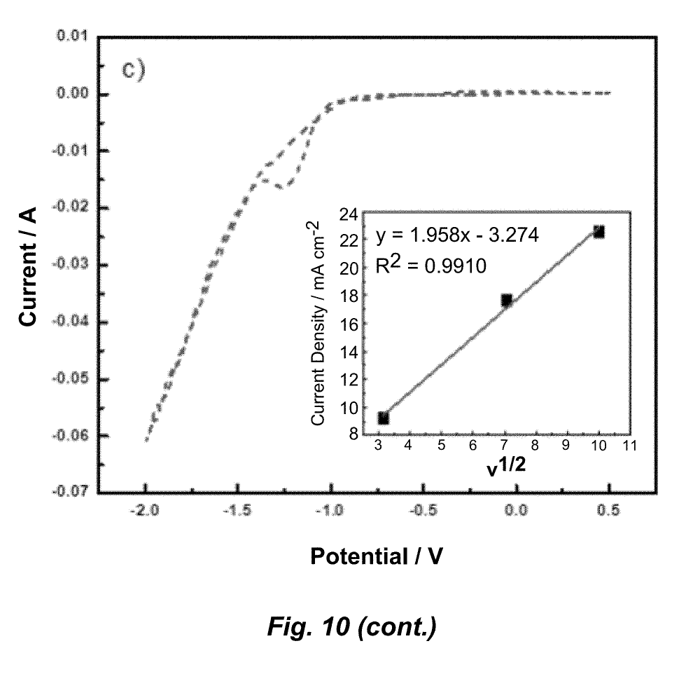

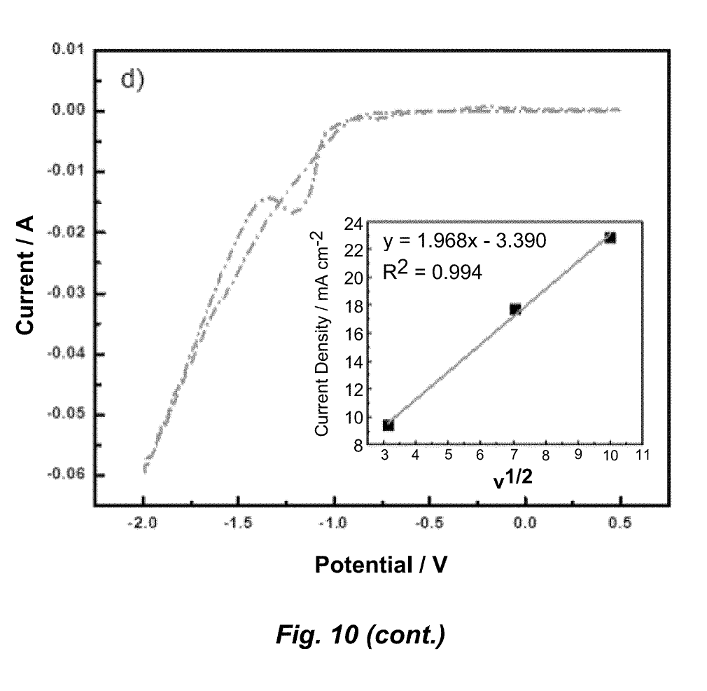

The bath modifications and plating conditions were checked with cyclic voltammetry (CV) studies to determine if addition of LDH to the plating bath affected the deposition potential for nickel or inhibited the current density. Research showed that the presence of butanol causes a cathodic shift in the reduction potential of nickel by destabilizing the nickel borate complex in the double layer and by adsorbing on the electrode. CVs of the plating solutions with and without LDH were run and the resulting reduction peak potentials (E_{pc}) along with current peak values (I_{pc}) are listed in Table 1B. In addition, FIG. 10 (a-d) shows the CV scans of the plating solutions. There is no significant shift in the reduction potential for nickel when LDH nanoparticles are present in the plating solution. The reduction peak potential, E_{pc}, averages around −1.23 V for all the solutions. Also, the peak current remains in the 15-16 mA range for all plating solutions. The inset for each graph is a Randles-Sevcik plot of current density versus square root of the scan rate. Current density increased linearly with the square root of scan rate for all plating solutions. All CVs had a crossover point near −1.08 V for all the plating baths, indicating nucleation of nickel onto the electrode during scanning. CV studies show that in the presence of the non-electroactive nanoparticle LDH platelets, there is no effect on the reduction potential of nickel for the solutions.

TABLE 1B
Reduction potentials and maximum currents
measured from cyclic voltammetry.

| Plating | E_{pc} | I_{pc} |
|---|---|---|
| Solution | (V vs. SCE) | (mA) |
| B1 | −1.244 | 14.91 |
| B2 | −1.209 | 16.14 |
| BL1 | −1.259 | 16.35 |
| BL2 | −1.213 | 16.70 |

### Characterization of Electrodeposited Nickel-LDH Coatings

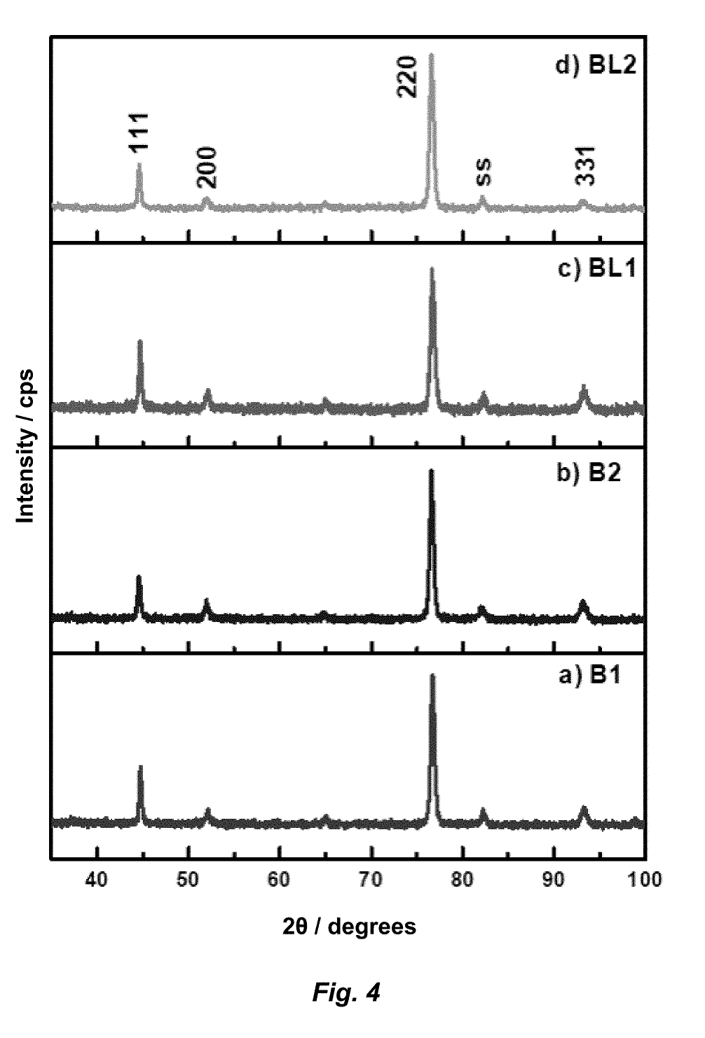

FIG. 4 shows the pXRD patterns for the electrodeposited pure Ni and Ni-LDH coatings. All the coatings have a preferred (220) orientation. Incorporation of LDH platelets into the coating does not affect the crystal orientation of the Ni-LDH nanocomposite coatings. To determine other effects of LDH inclusion, Williamson-Hall analysis was used to measure crystallite size and particle strain for the coatings. Results as listed in Table 2 confirm the coatings are nanocrystalline with crystallite size ranging from ˜25 to 60 nm. Incorporation of LDH into the nickel coating causes a decrease in crystallite size and indicates that LDH nanoparticles in the coating disrupt crystalline growth. BL1 with less LDH in the film has a crystallite size of ˜41 nm, while BL2 containing more LDH nanoparticles has a crystallite size of ˜25 nm. For all coatings, strain was minimal, indicating relaxation during crystal growth, even during LDH inclusion. Relative texture coefficients (RTC) calculated for the coatings and values are also listed in Table 2. All samples have a strong (220) character with smaller amounts of (111), (200), and (311) growth. B1 and B2 have (220) coefficients of 75.93 and 72.36, respectively, which is consistent with previous analysis of nickel coatings deposited by an electrochemical method. Samples BL1 and BL2 have higher (220) character, showing that the lateral growth planes expressed by the (220) reflection are inhibited when there is LDH platelet inclusion in the nickel matrix.

TABLE 2
Crystallite size and strain measured from Williamson-Hall analysis and results of relative
texture coefficient analysis of the XRD patterns of Ni and Ni-LDH coatings.

| | Crystallite | | | | | |
|---|---|---|---|---|---|---|
| | size (nm) | Strain | RTC₁₁₁ | RTC₂₀₀ | RTC₂₂₀ | RTC₃₁₁ |
| B1 | 37.54 ± 27 | 0.0228 ± 0.013 | 10.04 ± 5.5 | 5.84 ± 2.2 | 75.93 ± 9.0 | 8.19 ± 1.5 |
| B2 | 60.20 ± 21 | 0.0192 ± 0.001 | 9.86 ± 6.0 | 8.66 ± 4.6 | 72.36 ± 12.0 | 9.12 ± 2.0 |
| BL1 | 41.16 ± 2 | 0.0120 ± 0.007 | 6.25 ± 0.2 | 3.40 ± 1.0 | 84.94 ± 4.5 | 5.41 ± 3.3 |
| BL2 | 25.10 ± 6 | 0.0158 ± 0.017 | 8.22 ± 1.8 | 5.88 ± 3.3 | 78.91 ± 8.6 | 6.99 ± 3.7 |

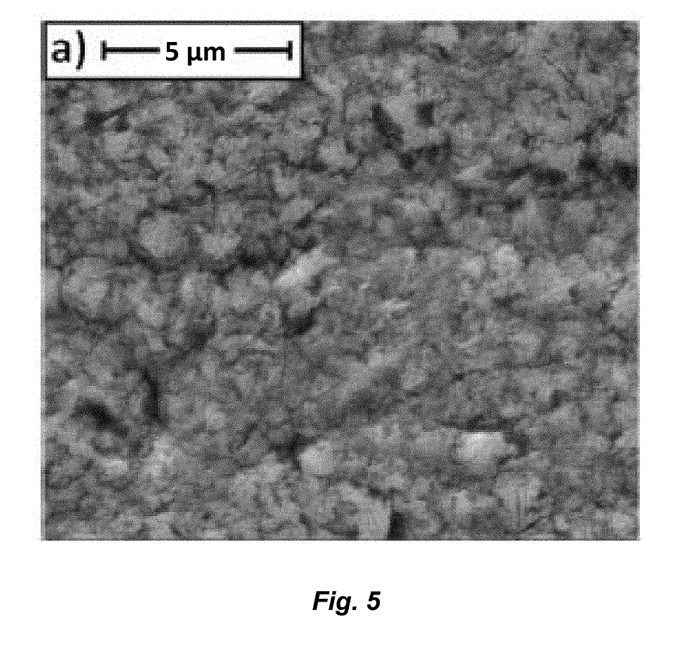

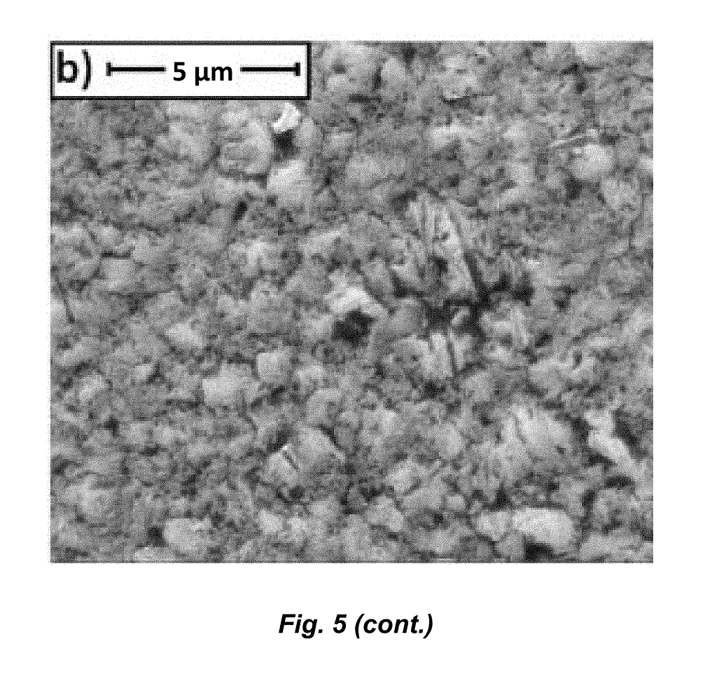

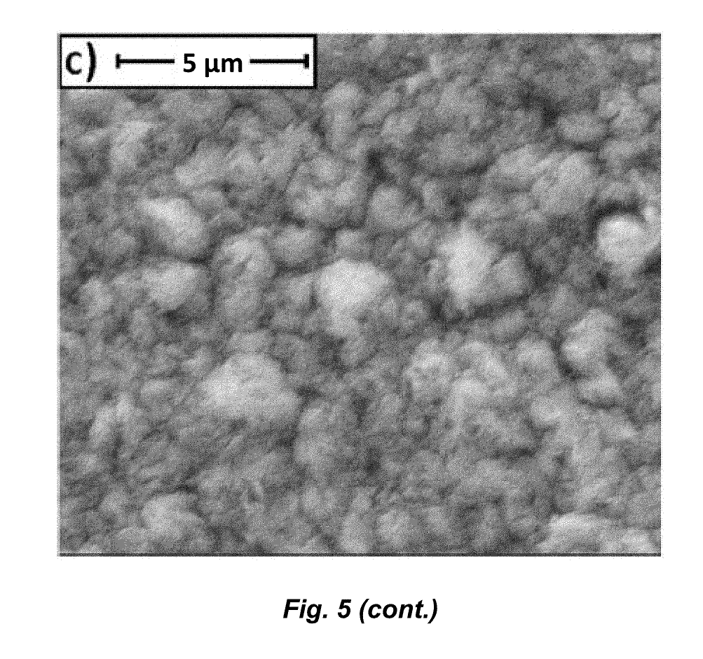

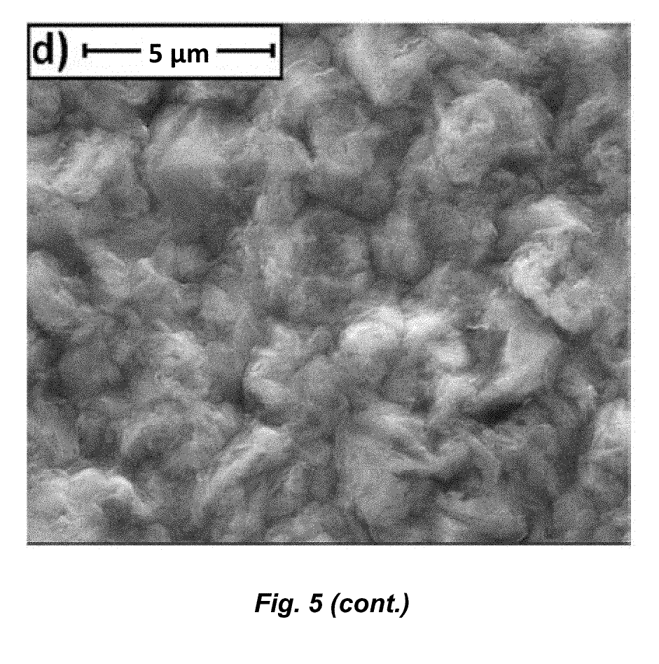

SEM and EDS analysis were run to determine surface morphology and chemical composition of the coatings (FIG. 5 and Table 3). All SEM images show dense compact crystalline films for both pure nickel and nickel nanocomposite coatings. EDS analysis determines elemental composition on the coating surfaces and can help determine if LDH is present in the coatings. The values for Ni, Al, and Zn are listed in Table 3. Aluminum was present in all coatings, since alumina is used in the polishing preparation process for the substrate surfaces. However, aluminum concentration for the pure nickel coatings, samples B1 and B2, was lower than those percentages in the nanocomposite coatings. The zinc concentration for the pure nickel samples was below the limit of detection of the experiment. The LDH containing nanocomposite samples, BL1 and BL2, had zinc concentration of 0.565% and 0.595%, respectively, indicating successful inclusion of LDH nanoparticles into the coatings.

TABLE 3
EDS elemental analysis results for Ni, Al, and Zn
of the electrodeposited coatings.

| | % Ni | % Al | % Zn |
|---|---|---|---|
| B1 | 99.66 | 0.338 | — |
| B2 | 99.63 | 0.370 | — |
| BL1 | 98.97 | 0.468 | 0.565 |
| BL2 | 98.83 | 0.575 | 0.595 |

Hardness and elastic modulus were measured via nanoindentation, with a depth profile of roughly 5% of total coating thickness. In addition, Table 4 displays the hardness and elastic modulus values for the coatings. Hardness values for all coatings are in the range of 6-7 GPa, with BL1 displaying slightly better hardness. These hardness values are in the same range as for nanocrystalline nickel coatings. Li et. al (Chemical Eng. J. 2008, 144, 124-137.) reported that monolayer LDH displays remarkable flexibility, which suggests that unlike other ceramic additives to Ni composite coatings, LDH would not lead to a large increase in hardness for the composite. This small effect in hardness for the composite coatings has been observed in untreated nickel-carbon nanotube composites as well. Elastic modulus values also show little change when LDH is dispersed into the nickel matrix and range from ˜195 to 240 GPa.

TABLE 4
Hardness and elastic modulus values
for Ni (B1, B2) and Ni-LDH (BL1, BL2) coatings.

| | Hardness (GPa) | Elastic Modulus (GPa) |
|---|---|---|
| B1 | 6.11 ± 0.07 | 239.90 ± 5.84 |
| B2 | 6.43 ± 0.37 | 200.28 ± 11.92 |
| BL1 | 6.90 ± 0.18 | 194.73 ± 4.46 |
| BL2 | 6.07 ± 0.15 | 205.16 ± 10.01 |

### Corrosion Resistance of Ni-LDH Coatings

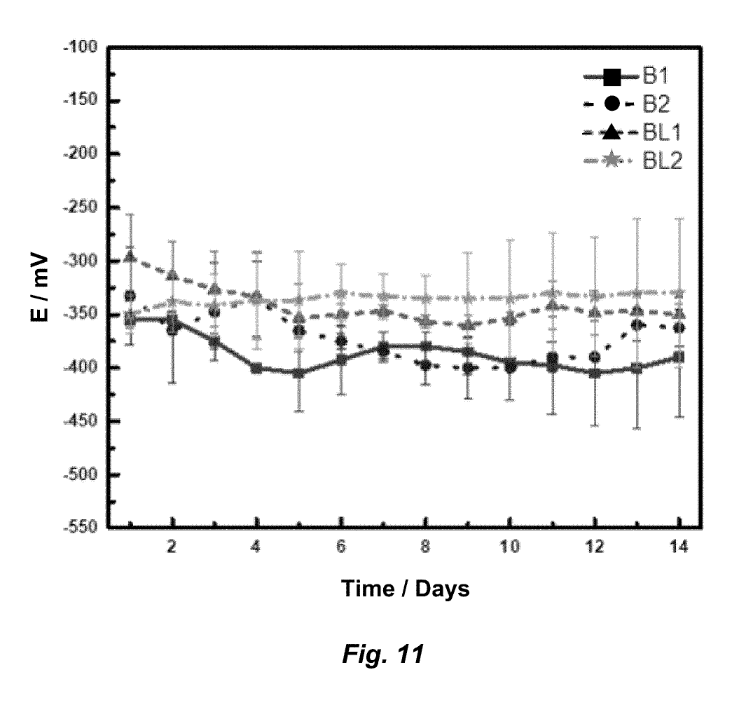

After deposition, all samples were rinsed thoroughly with DI water, dried with nitrogen gas, and immersed in 3.5% NaCl solution to monitor the passivation and corrosion processes. The open circuit potential (OCP) for the coatings was initially monitored for 14 days to assess the degree of passivation for all samples (FIG. 11). After 14 days, the pure nickel coatings, B1 and B2, have OCP values cathodic to the nanocomposite coatings, and small visible signs of Fe₂O₃ corrosion products on the coating surface indicate attack by the salt solution and subsequent coating failure. For the nanocomposite coatings, BL1 and BL2, OCP stabilizing around −0.350 V, indicates a slow passivation process for the oxide film growth. To study the growth of the passivating oxide for Ni and Ni-LDH coatings, 4 days' immersion was selected for samples B1 and B2, and 10 days for BL1 and BL2. These times were selected since they were prior to the appearance of corrosion products on the coating surface. Samples BL1 and BL2 were also tested at 4 days immersion to show the slower passivation rate due to LDH inclusion. The LDH inclusion did seem to slow the passivation process (formation of an oxide film) and additional corrosion tests were run to study this effect.

### Electrochemical Impedance Spectroscopy

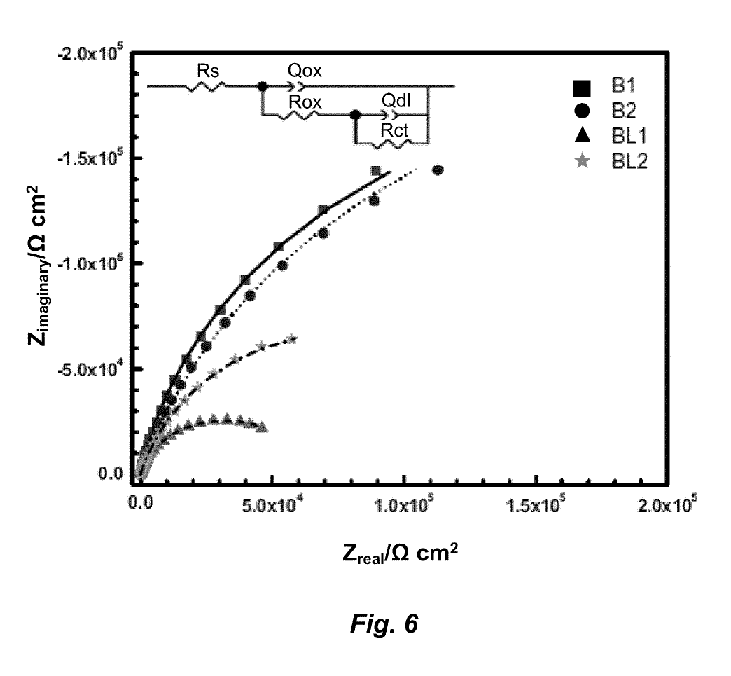

Electrochemical impedance spectroscopy (EIS) was run on each sample coating after immersion in a 3.5% NaCl solution for times discussed in the previous section. Once a stable OCP was reached, typically after a 1 hr immersion in fresh 3.5% NaCl solution, the coatings were scanned by EIS. Nyquist plots for the coatings (FIG. 6) display a single semicircle loop. Next, ZView software was used to fit and analyze the EIS data and predict the corrosion behavior of the coatings based on a circuit model.

Based on the OCP studies, and SEM results, a circuit was chosen that describes a porous oxide layer present at the surface interface, with an intact nickel or Ni-LDH layer underneath. The selected circuit has a solution resistance, a constant phase element and resistance for the porous oxide layer, and a constant phase element and resistance for the interface at the surface of the nickel or Ni-LDH coatings. The selected circuit model comprises three resistors and two constant phase elements (inset FIG. 6). Resistors include a value for the solution resistance (Rₛ), the resistance of the nickel oxide layer (Rₒₓ), and the charge transfer resistance of the coating (R_{ct}). Each constant phase element has two values: Q, an equivalent capacitance calculated from the parameters found from fitting the data with the selected circuit diagram, and a coefficient α, which represents a measure of similarity to a capacitor, ranging from 0 to 1 with 1 being identical to a capacitor. Qₒₓ represents the behavior of the oxide layer formed after immersion and is associated with α₁. It does not behave as a true capacitor since it is a porous oxide layer. Q_{dl} and the associated α₂, represent the behavior of the double layer capacitance between the electrolyte and coating interface.

The solution resistance, Rₛ value is affected by the distance between the counter electrode and coating samples in solution and is between 14.5-17.1 Ωcm², shown in Table 5, for all samples, which are typical values for these salt solutions. The pure nickel samples, B1 and B2 have larger Rₒₓ values, at 331.8 and 229.4 kΩcm², which indicates a well-formed oxide layer. The Ni-LDH coating samples have lower Rₒₓ values than B1 or B2 at only 4 days of immersion time, as indicated by the much smaller semicircle patterns in the Nyquist plots.

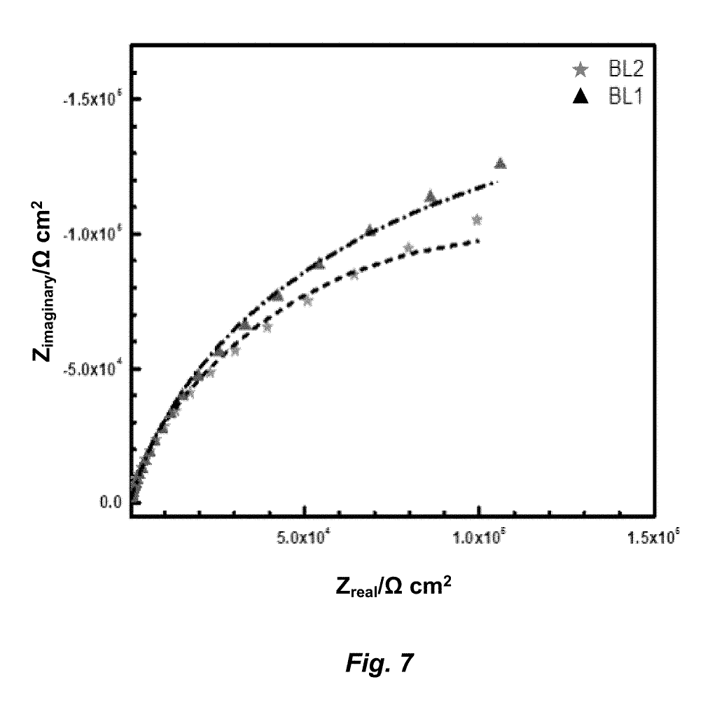

Comparing the spectra of BL1 and BL2 after 10 days immersion however, it is evident that oxide layer formation was still occurring between days 4 and 10, as shown in FIG. 7, but Rₒₓ values for the nanocomposite coatings are still lower than pure nickel coatings, with values of 119.2 and 115.7 kΩcm², respectively. The lower Rₒₓ values suggest that the inclusion of LDH into the nickel coating does slow the rate of nickel oxide formation and hinders the formation of the passive oxide layer. This slower rate of oxide growth is even more evident if you compare the ZView values for the BL1 and BL2 coatings for 4 days and 10 days. The oxide layer formed after 10 days may be thinner than that of their B1 and B2 counterparts, or oxide formation may be incomplete in areas of LDH presence at the surface of the coatings. However, the oxide layer capacitance, Qₒₓ, of BL1 and BL2 has higher values at 10.0 and 12.8 μFcm² after 10 days, which shows that if there are any gaps present in the oxide layer, the presence of LDH has an effect at the interface. This effect could not be explicitly discerned from the spectra, so it was not included as part of the circuit. Additionally, comparison between 4 to 10 days for BL1 and BL2 show a consistent increase in capacitance. The increase in capacitance would also have a slowing effect on the formation of the nickel oxide layer.

The R_{ct} values for B1 and B2 coatings are much lower than the nanocomposite coatings for either Ni-LDH measurement time. This indicates that the inclusion of LDH nanoplatelets leads to higher R_{ct} values for the nanocomposite coatings and an improvement in corrosion resistance, even though the oxide layer formation for the composite coatings may be slower. The Ni-LDH coating may have a lower active area available for the corrosion attack when compared to the nickel coatings. Similar results have been seen for other electrochemically deposited nickel nanocomposite coatings, which also used the same circuit diagram. In those studies, the R_{ct} value increased and corrosion resistance improved with the addition of ceramic nanoparticles such as Al₂O₃ or SiC into the nickel coating compared to the nickel only coating.

TABLE 5
Electrochemical impedance spectroscopy data for B1 and B2 after 4 days,
and BL1 and BL2 after 10 days immersion in 3.5% NaCl solution.

| | Immersion | Rₛ | Qₒₓ | | Rₒₓ | Q_{dl} | | R_{ct} |
|---|---|---|---|---|---|---|---|---|
| | (d) | (Ωcm²) | (uFcm⁻²) | α₁ | (kΩcm²) | (uFcm⁻²) | α₂ | (kΩcm²) |
| B1 | 4 | 14.5 ± 2.8 | 7.9 ± 0.3 | 0.895 | 331.8 ± 68.7 | 1.6 ± 0.7 | 0.741 | 1.4 ± 0.2 |
| B2 | 4 | 17.1 ± 0.9 | 7.2 ± 1.9 | 0.861 | 229.4 ± 20.8 | 4.5 ± 0.3 | 0.820 | 1.7 ± 0.5 |
| BL1 | 4 | 15.2 ± 1.5 | 5.3 ± 0.4 | 0.865 | 10.4 ± 5.5 | 5.5 ± 0.9 | 0.670 | 93.4 ± 15.2 |
| | 10 | 15.9 ± 2.1 | 10.0 ± 0.5 | 0.788 | 119.2 ± 13.2 | 17.2 ± 1.5 | 0.899 | 138.9 ± 67.9 |
| BL2 | 4 | 16.5 ± 1.1 | 2.8 ± 0.8 | 0.812 | 7.8 ± 3.4 | 2.4 ± 0.3 | 0.704 | 323.1 ± 81.2 |
| | 10 | 15.1 ± 1.7 | 12.8 ± 3.5 | 0.849 | 115.7 ± 22.3 | 22.0 ± 1.1 | 0.931 | 102.7 ± 23.4 |

### Potentiodynamic Polarization

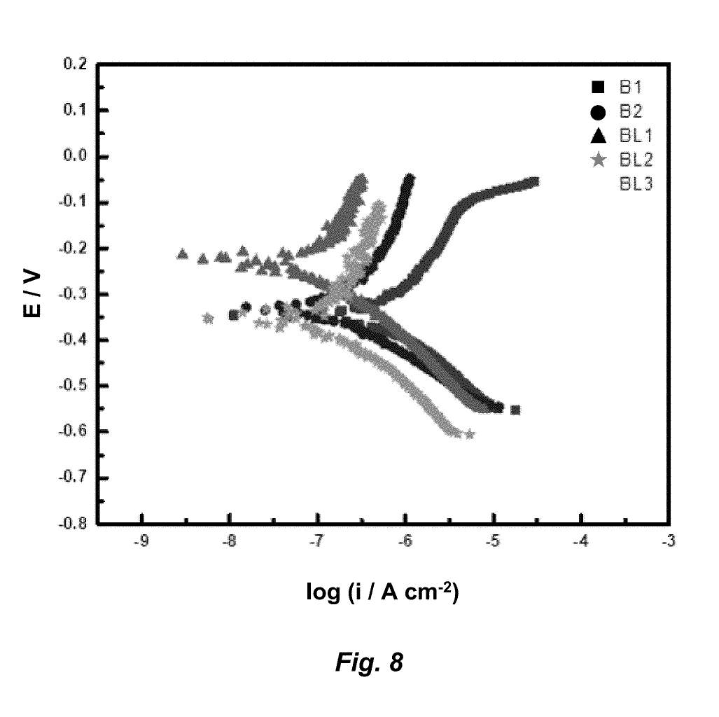

Each sample was analyzed using linear polarization resistance (LPR) and potentiodynamic polarization. From LPR, the polarization resistance, Rₚ, was calculated to determine the overall corrosion resistance of the films. Corrosion potential (E_{corr}), and the anodic (βₐ) and cathodic (β_{c}) slopes were measured from the potentiodynamic scans (FIG. 8). The corrosion current, i_{corr}, was then determined from the Stern-Geary equation. Results of the LPR and potentiodynamic polarization measurements are listed in Table 6. For all coatings, E_{corr} values are similar, with E_{corr} of BL1 shifted ˜60 mV anodic to the other samples. Rₚ for all samples is above 200 kΩ cm² and confirms good corrosion resistance. B1 displaying the largest Rₚ value indicates the coating has a well-formed oxide layer, consistent with EIS results. Data for the LDH containing samples confirms a trend that indicates LDH inclusion does improve corrosion resistance. Though BL1 manifest a relatively low Rₚ, at 232.3 kΩcm², BL2, with higher percentage of LDH in the coating, has the second largest Rₚ values at 342.5 kΩcm². This difference suggests that increased LDH percentage in the coating does improve corrosion resistance but the inclusion of LDH slows the formation of the passive oxide layer. Any LDH at the surface is likely to create breaks or holes in the passive oxide layer, since nickel oxide would not readily form over the top of the platelets.

The anodic slope of the potentiodynamic polarization curve, βₐ shows this in more detail. B1 displays a lower anodic slope value than B2 by 100 mVdec⁻¹. This same trend is true for BL1 and BL2. Both BL1 and BL2 have an observed slope increase of 100 mVdec⁻¹ compared to the control nickel samples, due to the inclusion of LDH. This shows that addition of LDH nanoparticles does help improve coating corrosion resistance, and the difference between the BL1 and BL2 slopes is the same as that of B1 and B2, consistent with the increase in BuOH addition in the plating bath. No significant difference in cathodic slopes (β_{c}) again suggests that all coatings were measured at the same degree of passivation. The i_{corr} values for the Ni and Ni-LDH coatings are all within the same range indicating a relatively slow corrosion rate. With Zn as the divalent metal in the LDH coatings, some small amount of sacrificial corrosion could be occurring. Also likely is some ion exchange of chloride ions with the surface hydroxide in the LDH crystal lattice. This mechanism shows a harmful anion uptake mechanism that leads to a lower pH near any corrosion sites, thereby providing an additional beneficial mechanism against corrosion.

TABLE 6
Potentiodynamic polarization data for B1 and B2 after 4 days, and BL1 and BL2 after
10 days immersion in 3.5% NaCl.

| | E_{corr} (V vs. SCE) | i_{corr} (μAcm²) | β_{c} (V dec⁻¹) | βₐ (Vdec⁻¹) | Rₚ (kΩcm²) |
|---|---|---|---|---|---|
| B1 | −0.330 ± 0.03 | 0.363 | −0.167 ± 0.004 | 0.323 ± 0.13 | 412.5 ± 18.4 |
| B2 | −0.323 ± 0.02 | 0.465 | −0.158 ± 0.034 | 0.433 ± 0.18 | 232.4 ± 22.8 |
| BL1 | −0.273 ± 0.06 | 0.469 | −0.158 ± 0.030 | 0.427 ± 0.23 | 232.3 ± 10.3 |
| BL2 | −0.315 ± 0.04 | 0.391 | −0.200 ± 0.050 | 0.567 ± 0.16 | 342.5 ± 27.7 |

Incorporation of delaminated LDH platelets into a metal matrix increases the corrosion resistance over pure metal films. The divalent and trivalent metals in the LDH structure result in a nanocomposite coating material having improved corrosion resistance. The nanocomposites described herein can include divalent and trivalent metals combinations such as Zn/Al as well as Mg/Al, Ni/Al, Ni/Cr, and/or Zn/Cr. These combinations provide advantageous properties such as inertness, stability, and the ability to form oxides when exposed to corrosive environments, as well as the ability to optimize the plating process and fine-tune corrosion resistance.

In conclusion, this work describes the addition of an anionic clay (LDH) into a nickel matrix to produce a nanocomposite coating using electrochemical deposition. Obstacles that complicate the production of these coatings are explained and solutions are outlined. Layered double hydroxide platelets are synthesized by a coprecipitation method. The intercalation of sodium dodecyl sulfate into the LDH layers helps in delamination of the platelets to give a 1.5 g/L loading in BuOH. Dispersion of the LDH platelets into an aqueous plating solution has no effect on the deposition potential of nickel but does affect the grain size of the coatings. Powder XRD and Williamson-Hall analysis show incorporation of the nanoplatelets into the coatings lowers crystallite size, which is beneficial for corrosion resistance. EDS results indicate the presence of the LDH nanoplatelets in the nickel coatings. The addition of LDH in the coating slows the growth rate of the passive oxide layer based on long-term immersion and EIS testing. The LDH platelets in the coatings slow the initial oxidation process of the nickel at the surface-solution interface and create a more tortuous path for solution to substrate electron transfer. Ni-LDH composite coatings display a larger coating charge transfer resistance, which indicates that Ni-LDH will perform better than pure nickel coatings in an aggressive chloride media. Different combinations of LDH structures and metal matrices can be tuned for specific environmental concerns. Their creation using a low cost, room temperature, electrodeposition process that is scalable and flexible is now possible based on the techniques described herein.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1. Synthesis of LDH-NO₃ Powder

All reagents were analytical grade and were used as-received, with no further processing. Nitrate (NO₃⁻) containing layered double hydroxide was synthesized from inorganic salts by a coprecipitation method. A 600 mL solution containing 0.016 M Zn(NO₃)₂.6H₂O (Alfa Aesar) and 0.008 M Al(NO₃)₃.6H₂O (Alfa Aesar) was stirred and refluxed under nitrogen atmosphere in decarbonated DI water at constant pH 10 (adjusted with 12.5 M NaOH (Fisher)) and 95° C. for 24 hrs. The solution was then aged for 24 hrs at room temperature. The resulting solid white product was centrifuged three times while rinsing first with decarbonated water and then twice with ethanol. The centrifuged powder was then dried in an oven at 100° C. for 12 hrs.

### Example 2. Synthesis of LDH-Dodecyl Sulfate (LDH-DS) Powder

LDH-DS powder was formed by dissolving 2.00 g of the dried LDH-NO₃ and 5.00 g of sodium dodecylsulfate (SDS) (Fisher) in 600 mL of decarbonated water. The solution was stirred under nitrogen at 23° C. for 72 hrs. The resulting solid white product was centrifuged, then washed repeatedly first with decarbonated water and then twice with ethanol prior to drying at 100° C. for 12 hrs.

### Example 3. Preparation of Colloidal Delaminated LDH Suspension

LDH-DS powder (0.200 g) was added to 100 mL butanol (BuOH) (Mallinckrodt), sealed under nitrogen and refluxed at 120° C. for 16 hrs, according to the procedure used by Adachi-Pagano (Chem. Commun. 2000, 91-92). During this procedure, a translucent layer and a miniscule solid layer were observed. To calculate the percent loading of delaminated LDH in the colloid, the solid was collected and weighed and the colloidal suspension was determined to be ˜1.5% LDH by weight. This colloidal suspension was stored under nitrogen atmosphere until needed.

### Example 4. LDH-NO₃ and LDH-DS Characterization

Characterization of synthesized LDH was carried out post drying for both LDH-NO₃ and LDH-DS powders. Infrared spectroscopy of the powders was done on a Perkin Elmer Spectrum One FTIR Spectrometer scanning from 450-4000 cm⁻². Powder x-ray diffraction (pXRD) was performed on a Rigaku Ultima IIIX-ray diffractometer using a copper x-ray source at 35 kV and 24 mA. Samples were scanned from 0.5° to 60° 2θ, at step size 0.05 degrees and dwell time 1.0 sec. Elemental analysis was done with atomic absorption spectroscopy (AAS) using a Perkin Elmer Analyst 300 with both Zn and Al hollow cathode lamps. Dried LDH powder was digested in a 50/50 nitric acid/perchloric acid solution, then diluted with ultrapure water (18.2 MΩ) for AAS elemental analysis. AAS results were quantified using a standard calibration curve. Particle size of both the LDH suspension and electrochemical baths was measured by dynamic light scattering (DLS) with a Beckman Delsa Nano-HC. LDH colloids were diluted with ultrapure water (18.2 MΩ) and allowed to equilibrate for 60 minutes prior to DLS analysis.

### Example 5. Electrodeposition of Ni and Ni-LDH Coatings

Before deposition, cyclic voltammetry (CV) for the plating baths was run using a Pine Wave Now potentiostat to determine the best plating conditions for the coatings. CVs were run at 10, 50 and 100 mV/s scan rates, starting from −0.245 V and scanning between −2.0 V and 0.5 V, respectively, then returning to −0.245 V. An EG&G PAR potentiostat/galvanostat model 273A was used for all depositions. The substrate was 430 stainless steel disks mounted in epoxy to expose only one face and polished using 400 to 1200 grit SiC paper. A final polish using a 1.0 μm alumina suspension on a felt pad was done to obtain a mirror finish.

Prior to plating, all electrodes were exposed to 5.0 M H₂SO₄ (EM Scientific) for 120 s, rinsed with DI water, and dried under nitrogen. Electrodeposition for both Ni and Ni-LDH films was done using a modified pulse-reverse loop comprising −1.08 V for 10 sec followed by −0.6 V for 4 s, scanning at 100 mV/s between steps, until a total charge of ˜100 coulomb (C) was reached. A saturated calomel electrode (SCE) and coiled chromel wire were used as the reference and counter electrodes, respectively. For electrodeposition of the pure nickel coatings, the electrolyte bath composition consisted of 0.10 M NiSO₄ (Alfa Aesar) and 0.15 M Na₂B₄O₇ (Fisher) adjusted to pH 3 with 5 M H₂SO₄, and addition of 5% (B1) or 10% (B2) butanol (BuOH). For the Ni-LDH nanocomposite coatings, the electrolyte bath was the same except with the addition of a 5% BuOH containing delaminated LDH colloid (BL1), or a 10% BuOH containing delaminated LDH (BL2). All solutions were adjusted to pH 3.00±0.05 with 5.0 M H₂SO₄. All depositions were performed between 21-23° C.

### Example 6. Ni and Ni-LDH Coating Characterization

An Environmental FEI Quanta 200 scanning electron microscope (SEM) with an EDT detector coupled with an EDS energy-dispersive x-ray spectrometer was used to study the morphology of the coatings. Powder X-ray diffraction was run for the coatings and measured from 35° to 100° 2θ on a Seimens D-500 X-ray diffractometer using an x-ray copper x-ray source set to 35 kV and 24 mA and scanned at step size 0.05 degrees and 1 sec dwell time.

To determine the corrosion resistant properties of the Ni and Ni-LDH coatings, open circuit potential (OCP), electrochemical impedance spectroscopy (EIS), linear polarization resistance (LPR), and potentiodynamic polarization were carried out on an EG&G PAR Parstat 4000 potentiostat. The working electrode area was 0.785 cm². A SCE and platinum mesh electrode were used as the reference and counter electrodes, respectively. OCP studies were run for 4-10 days while immersed in 3.5% NaCl solution. EIS was performed after immersion, measured at frequencies from 1×10⁵ to 2×10⁻² Hz, with a perturbation amplitude of 10 mV. To determine polarization resistance (Rₚ) values, linear polarization resistance (LPR) was performed on coatings by scanning ±20 mV from OCP at a scan rate of 0.1667 mVs⁻¹. To determine E_{corr} and i_{corr} values, potentiodynamic polarization scans were subsequently performed from ±250 mV from OCP at a scan rate of 0.1667 mVs⁻¹ and calculated using the Stern-Geary equation.

Hardness and elastic modulus experiments were performed with a Hysitron TI Premier nanoindenter, using a Berkovich indenter tip, which utilized a constant stiffness standard hardness/modulus. Samples were tested fresh after electrodeposition and drying under N₂ gas. Samples were probed 4 times, in a 2×2 matrix with 10 μm spacing, to a depth of 300 nm under a constant 8000 μN applied force.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

What is claimed is:

1. A nickel-clay nanocomposite comprising:
a) nickel metal; and
b) a clay nanoplatelet comprising a delaminated layered double hydroxide having a divalent metal hydroxide and a trivalent metal hydroxide;
wherein the clay nanoplatelet is dispersed in the nickel metal to form a nickel-clay nanocomposite, and the nickel-clay nanocomposite comprises nickel crystallites having a dimension of about 10 nm to about 100 nm, and an X-ray reflection of 200, 220, 311, or a combination thereof.

2. The nanocomposite of claim 1 wherein the clay nanoplatelet has a lateral dimension of about 300 nm to about 3000 nm.

3. The nanocomposite of claim 1 wherein the divalent metal of the divalent metal hydroxide is zinc.

4. The nanocomposite of claim 1 wherein the trivalent metal of the trivalent metal hydroxide is aluminum.

5. The nanocomposite of claim 1 wherein the dimension of the nickel crystallites is about 20 nm to about 60 nm.

6. The nanocomposite of claim 1 wherein the X-ray reflection of the nickel crystallites is about 220.

7. The nanocomposite of claim 2 wherein the divalent metal of the divalent metal hydroxide is zinc, the trivalent metal of the trivalent metal hydroxide is aluminum, the nickel crystallites have a dimension of about 20 nm to about 60 nm and an X-ray reflection of about 220, and wherein the nickel-clay nanocomposite is electroplated to a metal surface and inhibits corrosion of the metal surface.

8. A method of inhibiting corrosion of a metal surface comprising coating the metal surface with the nanocomposite of claim 1, thereby inhibiting corrosion of the metal surface.

9. The method of claim 8 wherein the metal surface is coated by electrodeposition.

10. The method of claim 9 wherein the coating formed by electrodeposition has a polarization resistance (Rp) of about 200 kΩ cm² to about 500 kΩ cm².

11. A method of coating a metal surface with a corrosion inhibitor comprising:
a) delaminating a layered double hydroxide (LDH) with a (C₃-C₁₀)alkanol to form a delaminated layered double hydroxide colloid; and
b) electroplating a metal surface with an electrolyte mixture comprising the delaminated layered double hydroxide colloid and a nickel salt, wherein the metal surface is thereby electroplated with a coating of a nickel-clay nanocomposite;
wherein the nickel-clay nanocomposite comprises clay nanoplatelets and nickel crystallites;
wherein the clay nanoplatelets have a lateral dimension of about 300 nm to about 3000 nm and comprise a delaminated layered double hydroxide (DLDH) having a divalent metal hydroxide and a trivalent metal hydroxide;
wherein the nickel crystallites have a dimension of about 10 nm to about 100 nm, and an X-ray reflection of 111, 200, 220, 311, or a combination thereof.

12. The method of claim 11 wherein the divalent metal of the divalent metal hydroxide is zinc, and the trivalent metal of the trivalent metal hydroxide is aluminum.

13. The method of claim 11 wherein the LDH has a basal spacing of about 5 angstroms to about 50 angstroms.

14. The method of claim 12 wherein the LDH comprises an intercalated dodecylsulfate ion, wherein the LDH is a layered double hydroxide-dodecylsulfate (LDH-DS).

15. The method of claim 14 wherein the LDH-DS is delaminated with butanol.

16. The method of claim 14 wherein the LDH-DS is prepared from a layered double hydroxide-nitrate (LDH-NO₃).

17. The method of claim 16 wherein the LDH-NO₃ comprises a ratio of Zn:Al of about 2:1 to about 5:1.

18. The method of claim 11 wherein the electrolyte mixture comprises about 1 g/L to about 2 g/L of the delaminated layered double hydroxide colloid.

19. The method of claim 11 wherein the electrolyte mixture comprises a borate salt.

20. The method of claim 11 wherein the electrolyte mixture has a pH of about 2 to about 4.
